(19) United States
(12) Patent Application Publication
(10) Pub. No.: US 2017/0355133 A1
(43) Pub. Date: Dec. 14, 2017

(54) METHOD OF MANUFACTURING SOLID FREEFORM FABRICATION OBJECT

(71) Applicants: Yoshihito SHIMADA, Kanagawa (JP); Hiroyuki NAITO, Tokyo (JP); Hiroshi IWATA, Aichi (JP); Kenji SUGIURA, Kanagawa (JP); Yoshihiro NORIKANE, Kanagawa (JP)

(72) Inventors: Yoshihito SHIMADA, Kanagawa (JP); Hiroyuki NAITO, Tokyo (JP); Hiroshi IWATA, Aichi (JP); Kenji SUGIURA, Kanagawa (JP); Yoshihiro NORIKANE, Kanagawa (JP)

(21) Appl. No.: 15/619,953

(22) Filed: Jun. 12, 2017

(30) Foreign Application Priority Data
Jun. 13, 2016 (JP) 2016-117459
Apr. 14, 2017 (JP) 2017-080593

(51) Int. Cl. B29C 64/124; B29C 64/40; B33Y 30/00; B33Y 10/00

(52) U.S. Cl. CPC B29C 64/124; B29C 64/40; B33Y 30/00; B33Y 10/00

(57) ABSTRACT

A method of manufacturing a solid freeform fabrication object includes forming a layer by solidifying a curable liquid composition by a solidifying device to form a solidified layer, repeating the forming to laminate the solidified layer to form a model portion and a support to support the model portion, and removing the support, wherein the support includes a water decaying area and the area other than the water decaying area, the water decaying area forming a continuous area including the surface of the support in contact with the model portion and at least a part of the surface of the support not in contact with the model portion.

### CROSS-REFERENCE TO RELATED APPLICATIONS

This patent application is based on and claims priority pursuant to 35 U.S.C. §119 to Japanese Patent Application Nos. 2016-117459 and 2017-080593, filed on Jun. 13, 2016 and Apr. 14, 2017, in the Japan Patent Office, the entire disclosures of which are hereby incorporated by reference herein.

### BACKGROUND

### Technical Field

The present invention relates to a method of manufacturing a solid freeform fabrication object.

### Description of the Related Art

Additive Manufacturing (AM) is known as a three-dimensional printing technology to fabricate three-dimensional objects.

This technology calculates cross-sections sliced along the lamination direction of an object and forms and laminates respective layers according to the shape of the cross-sections to fabricate the object. As the method of manufacturing a three-dimensional object, for example, a fused deposition molding (FDM) method, an inkjetting method, a binder jetting method, a material jetting method, a stereo lithography apparatus (SLA) method, and a selective laser sintering method are known. Of these, a method is known in which an image of a photocurable liquid resin is formed at required positions of a fabrication object by the material jetting method and this process is repeated to form a multi-layered three-dimensional object.

In addition, by stereolithography according to the material jetting method, i.e., the inkjet method, it is possible to manufacture a solid form which is difficult to form in principle with a modeling material (for example, a form having an overhung portion). In such technologies, a method is generally employed which includes fabricating a support to support the model portion at the same time. A technology has been proposed which includes fabricating a support with the same material as for a model portion and removing the support in post-processing such as cutting and polishing.

Moreover, stereolithography by an inkjet method makes it possible to discharge respective fine droplets of different kinds of photocurable compositions having different properties from nozzles to conduct stereolithography. Therefore, a technology has been proposed in which a target object is formed with a photocurable resin composition to form a water-insoluble cured object, a support is formed with a photocurable resin composition to form a water-soluble cured object, and thereafter the support is dissolved in water to remove the support.

Moreover, a three-dimensional fabrication device has been proposed which forms a support shell with a support material to form a three-dimensional object.

### SUMMARY

According to an embodiment of the present invention, provided is an improved method of manufacturing a solid freeform fabrication object which includes forming a layer by solidifying a curable liquid composition by a solidifying device to form a solidified layer, repeating the forming to laminate the solidified layer to form a model portion and a support to support the model portion, and removing the support, wherein the support includes a water decaying area and an area other than the water decaying area, the water decaying area forming a continuous area including the surface of the support in contact with the model portion and at least a part of a surface of the support not in contact with the model portion.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an example of a solid freeform fabrication object before the support is removed;

FIG. 2 is a schematic diagram illustrating an example of forming a liquid film with a device for manufacturing a solid freeform fabrication object;

FIG. 3 is a schematic diagram illustrating an example of laminating the liquid film illustrated in FIG. 2 to form a solid freeform fabrication object;

FIG. 4 is a schematic diagram illustrating an example in which areas other than the area having water decaying property are disposed in pillar-like forms according to an embodiment of the present invention;

FIG. 5 is a schematic diagram illustrating an example in which areas other than the area having water decaying property are disposed in lattice-like forms according to an embodiment of the present invention;

FIG. 6 is a schematic diagram illustrating an example in which areas other than the area having water decaying property are disposed in stepping-stone-like forms according to an embodiment of the present invention; and

FIG. 7 is a schematic diagram illustrating an example of a model portion where the support is removed after fabrication.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc. in the present disclosure represent the same meaning, unless otherwise specified.

Method of Manufacturing Solid Freeform Fabrication Object

The method of manufacturing a solid freeform fabrication object of the present disclosure includes forming a layer by solidifying a curable liquid composition by a solidifying device to form a solidified layer, repeating the forming to laminate the solidified layer to form a model portion and a support to support the model portion, and removing the support, wherein the support has a water decaying area and an area other than the water decaying area, the water decaying area forming a continuous area including a surface of the support in contact with the model portion and at least a part of a surface of the support not in contact with the model portion. The method may include other optional process.

Normally, when solubility of a support is enhanced, the support is easily removed from a solid freeform fabrication object but supporting ability deteriorates. In addition, when the fabrication volume is increased by increasing the size of a fabrication device, the ability to hold a shape is insufficient. In view of the foregoing, the method of manufacturing a solid freeform fabrication object of the present disclosure was thus made. In the method of the present disclosure, a support is separated into a water decaying area and an area other than the water decaying area. In this structure, it is possible to meet the balance between the supporting ability and removability.

In the present disclosure, a support is fabricated including a water decaying area and an area other than the water decaying area as one independent support. When multiple independent supports are required during solid freeform fabrication, it is possible to use in combination with a support having only a water decaying area or a support having only an area other than the water decaying area. Since the support including a water decaying area and an area other than the water decaying area strikes a balance between supporting ability and removability, it is preferable to apply this support to a relatively large support of the multiple supports.

The support in the method of manufacturing a solid freeform fabrication object has at least one water decaying area. For this reason, the support can be easily removed.

The water decaying property means that when a cured object is dipped in water, the cured object is finely decomposed until the cured object cannot maintain the original form and properties.

As the support, it is preferable that the water decaying area have a compression stresses less than the area other than the water decaying area.

As the support, it is preferable that the water decaying area be a soft support having a small compression stress and the area other than the water decaying area be a hard support having a large compression stress.

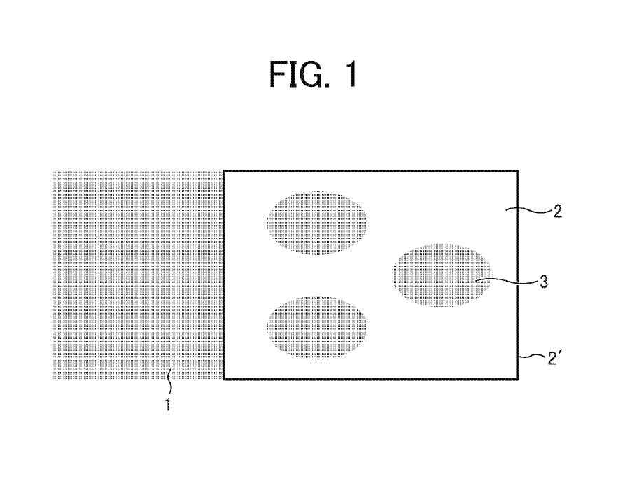

FIG. 1 is a diagram illustrating an example of a solid freeform fabrication object before the support is removed;

As illustrated in FIG. 1, it is preferable that an area other than the water decaying area 3 is includes in a water decaying area 2.

In addition, the area other than the water decaying area 3 is preferably present as multiple non-continuous areas in the support.

In terms of enhancing the water decaying property, the water decaying area 2 is formed as a single continuous area including a surface in contact with a model portion 1 and at least a part of a surface 2′ of the support.

The water decaying area preferably has a compression stress of less than 2 kPa at 1 percent compression and more preferably less than 5 kPa at 1 percent compression. When the compression stress at 1 percent compression is less than 2 kPa, it is easy to remove the water decaying area. The compression stress at 1 percent compression can be measured by a universal tester (AG-I, load cell: 1 kN, compression jig for 1 kN) manufactured by Shimadzu Corporation). In order to adjust the compression stress at 1 percent compression of the water decaying area within the range mentioned above, the kind and the content of the liquid to form the water decaying area are determined.

In the method of manufacturing a solid freeform fabrication object, it is preferable to further use the area other than the water decaying area. When the area other than the water decaying area is used, the support is constituted of the area other than the water decaying area to mainly support the model portion and the water decaying area to assist the area other than the water decaying area. Devising of their disposition, structure, etc. makes it possible to strike a balance between supporting ability and removability so that it is possible to render the model portion precise.

The area other than the water decaying area preferably has a compression stress of 2 kPa or greater at 1 percent compression. When the compression stress at 1 percent compression is 2 kPa or greater, the ability to support the model portion is excellent. The compression stress at 1 percent compression can be measured by a universal tester (AG-I, load cell: 1 kN, compression jig for 1 kN) manufactured by Shimadzu Corporation). In order to adjust the compression stress at 1 percent compression of the area other than the water decaying area within the range mentioned above, the kind and the content of the liquid to form the water decaying area are determined. The area other than the water decaying area is preferably formed of the same material as those for the model portion.

There is no specific limit to the form of the area other than the water decaying area. It can be suitably selected to suit to a particular application. For example, the area other than the water decaying area can be disposed in a pillar-like form, a lattice-like form, or a stepping stone-like form in the lamination direction.

The compression stress of the area other than the water decaying area at 1 percent compression is preferably 1.5 kPa or more greater than the compression stress of the water decaying area at 1 percent compression in terms of striking the balance between the support ability and removability.

The volume ratio {(water decaying area)/(water decaying area+area other than the water decaying area) is preferably from 50 percent to 95 percent, more preferably from 60 percent to 95 percent, and particularly preferably from 70 percent to 90 percent. When the volume ratio {(water decaying area)/(water decaying area+area other than the water decaying area) is 50 percent or greater, removability is improved. When the volume ratio is 95 percent or less, holding power due to moisture absorption and fabrication accuracy can be improved.

In addition, the support is not necessarily a uniform configuration but can be constituted of the water decaying area and the area other than the water decaying area to reinforce the water decaying area like reinforcing steel to support the model portion.

Layer Forming Process

The layer forming process is to solidify a curable liquid composition by a solidification device to form a layer.

The humidity in the fabrication area in the layer forming process is preferably 80 percent or less.

The layer forming process is preferably conducted employing an inkjet method or a dispenser method.

Curable Liquid Composition

Examples of the curable liquid composition are a liquid to form the water decaying area, a liquid to form the model portion, and a liquid to form the area other than the water decaying area.

The liquid to form the water decaying area can fabricate the water decaying area.

The model portion can be fabricated by the liquid to form the model portion.

The liquid to form the area other than the water decaying area can fabricate the area other than the water decaying area.

Liquid to Form Water Decaying Area

The liquid to form the water decaying area includes a monomer A having a hydrogen bond power, a solvent B having a hydrogen bond power, and other optional components.

The liquid to form the water decaying area preferably has water decaying property.

The water decaying property means that when a cured object is dipped in water, the cured object is finely decomposed until the cured object cannot maintain the original form and properties.

The liquid to form the water decaying area preferably satisfies the following Condition 1.

Condition 1

When a cured object (water decaying area) having a dimension of 20 mm×20 mm×5 mm obtained by irradiation of ultraviolet ray in an amount of 500 mJ/cm² with an ultraviolet irradiator is placed in 20 mL of water and left still at 25 degrees C. for one hour, the cured object is completely dissolved in the water or becomes a solid having a size of 1 mm or less at least in one direction.

The cured object having a dimension of 20 mm×20 mm×5 mm can be manufactured as follows.

A liquid to form the water decaying area is poured into a silicone rubber mold having a dimension of 20 mm×20 mm×5 mm and irradiated by an ultraviolet irradiator (SubZero-LED, manufactured by Integration Technology Japan) with ultraviolet in an irradiation amount of 500 mJ/cm² (illuminance: 100 mW/cm², irradiation time: 5 seconds) to obtain a cured object of 2 g of a support having a dimension of 20 mm×20 mm×5 mm.

The liquid to form the water decaying area preferably satisfies the following Condition 2.

Condition 2

When a cured object (water decaying area) of the water decaying area obtained by irradiation of ultraviolet ray in an amount of 500 mJ/cm² by an ultraviolet irradiator has a compression stress of less than 2.0 kPa at 1 percent compression at 25 degrees C. and 2 g of the cured object is placed in 20 ml of water and left still at 25 degrees C. for one hour, the cured object is reduced to 50 percent by volume or less.

The volume of the remaining solid can be measured by Archimedes' Law.

Monomer A Having Hydrogen Bond Power

The monomer having a hydrogen bond power has no specific limitation and can be suitably selected to suit to a particular application. For example, mono-functional monomers and multi-functional monomers are suitable. These can be used alone or in combination.

Of these, in order to improve water decaying property, mono-functional monomers are preferable.

As the monomer having a hydrogen bond power, for example, monomers having an amide group, an amino group, a hydroxyl group, a tetramethyl ammonium group, a silanol group, an epoxy group, sulfo group, etc. are suitable.

Specific examples of the polymerization reaction of the monomer having a hydrogen bond power include, but are not limited to, radical polymerization, ion polymerization, coordination polymerization, and ring-opening polymerization. Of these, in order to control polymerization reaction, radical polymerization is preferable. For this reason, as the monomer A having a hydrogen bond power, ethylenic unsaturated monomers are preferable and water-soluble mono-functional ethylenic unsaturated monomers and water-soluble multi-functional ethylenic unsaturated monomers are more preferable. Of these, water-soluble mono-functional ethylenic unsaturated monomers are particularly preferable in terms of the power of hydrogen bond.

Water-Soluble Mono-Functional Ethylenic Unsaturated Monomer Having Hydrogen Bond Power

As the water-soluble mono-functional ethylenic unsaturated monomer having a hydrogen bond power, for example, monomers including a mono-functional vinylamide group (N-vinyl-ε-caprolactam, N-vinylformamide, N-vinylpyrrolidone, etc.), (meth)acrylates including a mono-functional hydroxyl group (hydroxyethyl(meth)acrylate, hydroxypropyl(meth)acrylate, 4-hydroxybutyl(meth)acrylate, etc.), (meth)acrylate including a hydroxy group (polyethylene glycol mono(meth)acrylate, monoalkoxy(C1-C4)polyethylene glycol mono(meth)acrylate, polypropyleneglycol mono(meth)acrylate, monoalkoxy(C1-C14)polypropylene glycol mono(meth)acrylate, and mono(meth)acrylate of PEG-PPG block polymer), and (meth)acrylamide derivatives {(meth)acrylamide, N-methyl(meth)acrylamide, N-ethyl(meth)acrylamide, N-propyl(meth)acrylamide, N-butyl(meth)acrylamide, N,N′-dimethyl(meth)acrylamide, N-hydroxyethyl(meth)acrylamide, N-hydroxypropyl(meth)acrylamide, N-hydroxybutyl(meth)acrylamide, etc.}, and (meth)acryloyl morphorine are preferable. These can be used alone or in combination. Of these, in terms of optical reactivity, (meth)acylate and (meth)acrylamide derivatives are preferable and hydroxyethylacrylate, hydroxypropylacrylate, 4-hydroxybutylacrylate, acrylamide, acryloyl morphorine, N-methylacrylamide, N-ethylacrylamide, N-propylacrylamide, N-butylacrylamide, N,N′-dimethylacrylamide, N-hydroxyethylacrylamide, N-hydroxypropylacrylamide, N-hydroxybutylacrylamide, and diethylacrylamide are more preferable. In terms of low dermal irritancy, acryloyl morphorine and N-hydroxyethylacrylamide are particularly preferable.

Water-Soluble Multi-Functional Ethylenic Unsaturated Monomer Having Hydrogen Bond Power

Specific examples include, but are not limited to, as difunctional monomers, tripropyleneglycol di(meth)acrylate, triethyleneglycol di(meth)acrylate, tetraethyleneglycol di(meth)acrylate, polypropyleneglycol di(meth)acrylate, neopentyl glycol hydroxy pivalic acid ester di(meth)acrylate, hydroxypivalic acid neopentyl glycol ester di(meth)acrylate, 1,3-butanediol di(meth)acrylate, 1,4-butanediol di(meth)acrylate, 1,6-hexanediol di(meth)acrylate, 1,9-nonane diol(meth)acrylate, diethyleneglycol di(meth)acrylate, neopentyl glycol di(meth)acrylate, tripropyleneglycol di(meth)acrylate, caprolactone-modified hydroxy pivalic acid neopentyl glycol ester di(meth)acrylate, propoxinated neopentyl glycol di(meth)acrylate, polyethylene glycol 400 di(meth)acrylate, polyethylene glycol 200 di(meth)acrylate, and polyethylene glycol 400 di(meth)acrylate and as tri- or more functional monomers, triarylisocyanate and tris(2-hydroxyethyl)isocyanulate tri(meth)acrylate. These can be used alone or in combination.

The molecular weight of the monomer A having a hydrogen bond power is preferably from 60 to 300 and more preferably from 90 to 170. When the molecular weight is from 30 to 60, viscosity can be adjusted to be optimal for inkjet methods and toxicity (dermal irritation and mutagenicity) for a human being can be suppressed.

The proportion of the monomer A having a hydrogen bond power is preferably 30 to 60 percent by mass to the total content of the liquid to form the water decaying area. When the proportion is 30 to 60 percent by mass, the water decaying area strikes a balance between compression stress and water decaying property as a support to hold a shape.

Solvent B Having Hydrogen Bond Power

The solvent B having a hydrogen bond power has a hydrogen bond power with the monomer A having a hydrogen bond power and forms a hydrogen bond with the monomer A having a hydrogen bond power to demonstrate the feature as a support to hold a shape.

The solvent B is at least one of an alcohol compound, a carboxylic acid compound, an amine compound, an ester compound, a ketone compound, and a urea compound. Of these, alcohol compounds are preferable.

Alcohol Compounds

It is preferable that the alcohol compound have no reactivity with a water-soluble acrylic monomer, do not inhibit radical polymerization reaction during photocuring, have flowability at room temperature, and be soluble in water.

In addition, since both mono-functional and poly-functional alcohol compounds are used as the alcohol compound, diols having 3 to 6 carbon atoms are preferable in terms of volatility, viscosity, water decaying property, and mixability with monomers, etc.

Specific examples of the diol include, but are not limited to, propane diol, butane diol, pentane diol, and hexanediol. These can be used alone or in combination. Of these, 1,3-prpanediol, 1,2-propanediol (propyleneglycol), 1,4-butanediol, 1,5-pentanediol, and 1,6-hexanediol are preferable.

The number of carbon atoms is preferably from 3 to 6 and more preferably from 3 to 5. When the number of carbon atoms is 3 or more, the compression stress at 1 percent compression can be improved. When the number of carbon atoms is 6 or less, the viscosity of the liquid to form the water decaying area can be lowered.

The carbon chain of the diol having 3 to 6 carbon atoms may be straight or branched.

Carboxylic Acid Compound

Specific examples of the carboxylic acid compound include, but are not limited to, straight-chained aliphatic acids such as formic acid, acetic acid, propionic acid, butaric acid, pentanoic acid, and hexanoic acid, various branch-chained aliphatic carboxylic acids such as isobutyric acid, t-butyric acid, isopentyric acid, isooctyric acid, and 2-ethylhexyric acid, aromatic carboxylic acids such as benzoic acid and benzene sulfonic acid, and hydroxy carboxylic acid such as glycolic acid and lactic acid. These can be used alone or in combination. Of these, in terms of solubility in water, acetic acid, propionic acid, butyric acid, and lactic acid are preferable. More preferable are butyric acid and lactic acid.

Amine Compound

Specific examples of the amine compound include, but are not limited to, primary to tertiary amines such as monoalkyl amine, dialkylamine, and trialkylamine, divalent amines such as ethylene diamine, trivalent amines such as triethylene diamine, and aliphatic amines such as pyridine and aniline. These can be used alone or in combination. Of these, in terms of cross-linking strength due to hydrogen bond and solubility in water, divalent or trivalent primary amines are preferable. More preferable is ethylene diamine.

Ester Compound

Specific examples of the ester compound include, but are not limited to, mono-functional esters such as ethyl acetate, butyl acetate, and ethyl propionate, polyfunctional aliphatic esters such as dimethyl succinate and dimethyl adipate, and polyfunctional aromatic esters such as dimethyl terephthalate. These can be used alone or in combination. Of these, in terms of solubility in water, evaporation and smell during fabrication, and safety, dimethyl adipate is preferable.

Ketone Compound

Specific examples of the ketone compound include, but are not limited to, monofunctional ketones such as acetone and methylethyl ketone and multifunctional ketones such as acetylaceton and 2,4,6-heptatrione. These can be used alone or in combination. Of these, in terms of volatility and solubility in water, acetyl acetone is preferable.

The proportion of the solvent B having a hydrogen bond power is preferably 10 to 50 percent by mass to the total content of the liquid to form the water decaying area. When the proportion is 10 to 50 percent by mass, the water decaying area strikes a balance between compression stress as a support to hold a shape and water decaying property.

Mass Ratio A/B

The mass ratio (A/B) of the mass (percent by mass) of A to the mass (percent by mass) of B is preferably from 0.3 to 2.5 and more preferably from 0.5 to 2.5. When the mass ratio (A/B) is from 3 to 2, compression stress at 1 percent compression can be improved.

Polymerization Initiator

As the polymerization initiator C, any material can be used which produces a radical upon irradiation of light (ultraviolet having in a wavelength range of 220-400 nm).

Specific examples of the polymerization initiator C include, but are not limited to, acetophenone, 2,2-diethoxyacetophenone, p-dimethylaminoacetone, benzophenone, 2-chlorobenzophenone, p,p′-dichlorobenzophenone, p,p-bisdiethylamonobenzophenoen, Michler's Ketone, benzyl, benzoin, benzoin methylether, benzoin ethylether, benzoin isopropylether, benzoin-n-propylether, benzoin isobutylether, benzoin-n-butylether, benzylmethyl ketal, thioxanthone, 2-chlorothioxanthone, 2-hydroxy-2-methyl-1-phenyl-1-one, 1-(4-isopropylphenyl)-2-hydroxy-2-methylpropane-1-one, methylbenzoyl formate, 1-hydroxy cyclohexyl phenylketone, azobisisobutylo nitrile, benzoylperoxide, and di-tert-butylperoxide. These can be used alone or in combination. It is preferable to select a polymerization initiator depending on the ultraviolet wavelength of an ultraviolet irradiator.

The proportion of the polymerization initiator C is 5 to 10 percent by mass to the total content of the curable liquid composition.

Liquid to Form Model Portion

The model portion is fabricated by the liquid to fabricate the model portion.

The liquid to form the model portion has no particular limit and can be suitably selected to suit to a particular application. A specific example is AR-M1 (manufactured by KEYENCE CORPORATION).

Liquid to Form Area Other than Water Decaying Area

The liquid to form the area other than the water decaying area is used to fabricate the area other than the water decaying area.

The liquid to form the area other than the water decaying area may be the same as the liquid to form the model portion.

The liquid to form the area other than the water decaying area preferably satisfies the following Condition 1.

### Condition 1

A cured solid object of the area other than the water decaying area obtained by irradiation of ultraviolet in an amount of 500 mJ/cm² by an ultraviolet irradiator has a compression stress of 2.0 kPa or more at 1 percent compression at 25 degrees C. When the cured solid object of the area other than the water decaying area obtained by irradiation of ultraviolet in an amount of 500 mJ/cm² by an ultraviolet irradiator satisfies the above-mentioned condition, the function of the support to hold a shape can be improved.

There is no specific limitation to the surface tension of the curable liquid composition and it can be selected to suit to a particular application. For example, the surface tension is preferably from 20 to 45 mN/m and more preferably 25 to 34 mN/m. When the surface tension is 20 mN/m or greater, it is possible to prevent unstable jetting (deviation of jetting direction, no jetting, etc.) during fabrication is improved. When the surface tension is 45 mN/m or less, a discharging nozzle for fabrication (shape-forming) is easily filled with liquid.

Surface tension can be measured by a surface tensiometer (automatic contact angle DM-701, manufactured by Kyowa Interface Science Co., LTD.), etc.

Viscosity

The viscosity of the curable liquid composition at 25 degrees C. is preferably 100 mPa·s or less, more preferably 3 to 20 mPa·s, and particularly preferably 6 to 12 mPa·s.

When the viscosity is less than 100 mPa·s, discharging stability can be improved.

Viscosity can be measured by, for example, a rotation viscometer (VISCOMATE VM-150 III, manufactured by TOKI SANGYO CO., LTD.) in a 25 degrees C. environment.

Viscosity Change Rate

The viscosity change rate of the curable liquid composition is preferably from −20 to +20 percent and more preferably from −10 to +10 percent when the curable liquid composition is left undone at 50 degrees C. for two weeks.

When the viscosity change rate is from −20 to +20 percent, storage stability is good and discharging is stabilized.

The viscosity change rate between the viscosity before storage and the viscosity after the liquid is left undone for two weeks at 50 degrees C. can be measured in the following manner.

The curable liquid composition is placed in a polypropylene bottle (50 mL) and left undone for two weeks in a constant temperature tank at 50 degrees C. The liquid is taken out from the tank and left undone until the temperature thereof lowers to room temperature (25 degrees C.). Thereafter, viscosity is measured. The viscosity before placing the curable liquid composition in the constant temperature tank is determined as pre-storage viscosity and the viscosity thereof taken out from the constant temperature tank is determined as post-storage viscosity. The viscosity change rate is calculated according to the following relation. The pre-storage viscosity and the post-storage viscosity can be measured by, for example, an R type viscometer (manufactured by TOKI SANGYO CO., LTD.) at 25 degree C.

Viscosity change rate(percent)={(post-storage viscosity)−(pre-storage viscosity)]/(pre-storage viscosity)}×100

Other Components

The other optional components have no particular limit and can be suitably selected to suit to a particular application. For example, minerals dispersible in solvents, polymerization inhibitors, and curable liquid compositions, polymerizable monomers other than the A, thermal polymerization initiators, colorants, antioxidants, chain transfer agents, anti-aging agents, cross-linking promoters, ultraviolet absorbents, plasticizers, reservatives, and dispersants.

Solvent

Specific examples of the solvent include, but are not limited to, glycol, triol, ether, triethylene glyol, and polypropylene glycol. These can be used alone or in combination. Of these, in terms of mixability and water-solubility, ethylene glycol condensate and propylene glycol condensate are preferable.

The solubility parameter (SP) of the solvent is preferably 18 MPa^{1/2} or greater and more preferably 23 MPa^{1/2} or greater in terms of water decaying property.

Therefore, the proportion of the solvent to the total content of the curable liquid composition is preferably 50 percent by mass or less and more preferably 30 percent by weight or less.

Polymerization Inhibitor

Specific examples of the polymerization inhibitor include, but are not limited to, phenol compounds (hydroquinone, hidroquinone monomethyl ether, 2,6-di-t-butyl-p-cresol, 2,2-methylene-bis-(4-methyl-6-t-butylphenol), 1,1,3-tris-(2-methyl-4-hydroxy-5-t-butylphenyl)butane, etc.), sulfur compounds (dilaurylthio dipropionate, etc.), phosphorus compounds (triphenyl phosphite, etc.), and amine compounds (phenothiadine, etc.). These can be used alone or in combination.

The proportion of the polymerization inhibitor is 30 percent by mass or less and preferably 20 percent by mass or less to the total content of the curable liquid composition in terms of curable liquid composition.

Mineral Dispersible in Curable Liquid Composition

The mineral dispersible in the curable liquid composition has no specific limit and can be suitably selected to suit to a particular application. For example, lamellar clay mineral is suitable.

Specific examples of the lamellar clay mineral include, but are not limited to, smectite such as montmorillonite, beidellite, hectorite, saponite, nontronite, and stevensite, vermiculite, bentonite, lamellar sodium silicate such as kanemite, kenyaite and makatite. These can be used alone or in combination.

Such lamellar clay mineral may be either a naturally generated mineral or a mineral produced by a chemical synthesis.

The surface of the lamellar clay mineral can be subject to organic treatment.

The lamellar inorganic substance of the lamellar clay mineral is treated with an organic cationic compound so that the cations between layers can be ion-exchanged with cation groups of quarternary salts, etc.

Specific example of the cation of the lamellar clay mineral include, but are not limited to, metal cations such as sodium ion and calcium ion.

The lamellar clay mineral treated with the organic cationic compound is swollen or dispersed in the polymer and the polymerizable monomer mentioned above.

A specific example of the lamellar clay mineral treated with the organic cationic compound is Lucentite series (manufactured by Katakura & Co-op Agri Corporation). Examples of Lucentite series are Lucentite SPN, Lucentite SAN, Lucentite SEN, and Lucentite STN. These can be used alone or in combination.

Polymerizable Monomer

The polymerizable monomer has no specific limit and is suitably selected to suit to a particular application. For example, (meth)acrylate is usable.

Specific examples of the (meth)acrylates include, but are not limited to, 2-ethylhexyl(meth)acrylate (EHA), isobonyl(meth)acrylate, 3-methoxybutyl(meth)acrylate, lauryl(meth)acrylate, 2-phenoxyethyl(meth)acrylate, iisodecyl(meth)acrylate, isooctyl(meth)acrylate, tridecyl(meth)acrylate, caprolactone(meth)acrylate, and ethoxyfied nonylphenol(meth)acrylate. These can be used alone or in combination.

Thermal Polymerization Initiator

The thermal polymerization initiator has no particular limitation and can be suitably selected to suit to a particular application. Examples thereof are azo-based initiators, peroxides initiators, persulfate initiators, and redox (oxidation-reduction) initiators. In terms of storage stability, photopolymerization initiators are preferable to thermal polymerization initiators.

Specific example of the azo-based initiator include, but are not limited to, VA-044, VA-46B, VA-50, VA-057, VA-061, VA-067, VA-086, 2,2′-azobis(4-methoxy-2,4-dimethylvaleronitrile)(VAZO 33), 2,2′-azobis(2-amidinopropane)dihydrochloride (VAZO 50), 2,2′-azobis(2,4-dimetaylvaleronitrile) (VAZO 52), 2,2′-azobis(isobutylonitrile) (VAZO 64), 2,2′-azobis-2-methylbutylonitrile) (VAZO 67), and 1,1-azobis(1-cyclohexane carbonitrile) (VAZO 88) (all available from E. I. du Pont de Nemours and Company), 2,2′-azobis(2-cyclopropylpropionitrile), and 2,2′-azo-bis(methylisobutylate) (V-601) (all available from Wako Pure Chemical Industries, Ltd.).

Specific examples of the peroxide initiator include, but are not limited to, benzoyl peroxide, acetyl peroxide, lauroyl peroxide, decanoyl peroxide, dicetyl peroxy dicarbonate, di(4-t-butylcyclohexyl)peroxy dicarbonate (Perkadox 16S) (available from Akzo Nobel), di(2-ethylhexyl)peroxy dicarbonate, t-butyl peroxypivalate (Lupersol 11) (all available from Elf Atochem), t-butylperoxy-2-ethyl hexanoate (Trigonox 21-050) (available from Akzo Nobel), and dicumyl peroxide.

Specific examples of the persulfate initiator include, but are not limited to, potassium persulfate, sodium persulfate, and ammonium persulfate.

Specific examples of redox (oxidation-reduction) initiator include, but are not limited to, a combination of the persulfate initiator and a reducing agent such as methacid sodium sulfite and acid sodium sulfite, a system based on the organic peroxide and tertiary amine (such as a system based on benzoyl peroxide and dimethylaniline), and a system based on organic hydroperoxide and transition metal (such as a system based on cumenhydroperoxide and cobalt naftate).

Colorant

Examples of the colorant are pigments and dyes.

Examples of the pigment are organic pigments and inorganic pigments.

Specific examples of the organic pigments include, but are not limited to, azo pigments, polycyclic pigments, adine pigments, daylight fluorescent pigments, nitoro pigments, nitroso pigments, and natural pigments.

Examples of the inorganic pigment are metal oxides (iron oxide, chromium oxide, and titanium oxide) and carbon black.

Anti-Oxidant

Specific examples of the antioxidant include, but are not limited to, phenol compounds (monocyclic phenol (2,6-di-t-butyl-p-cresol, etc.), bisphenol (2,2′-methylene-bis-(4-methyl-6-t-butylphenol, etc.), polycyclic phenol (1,3,5-trimethyl-2,4,6-tris(3,5-di-t-buthyl-hydroxybenzyl) (benzene), etc.), sulfur compounds (dilauryl 3,3′-thio dipropionate, etc.), phosphorus compounds (triphenyl phosphite, etc.), and amine compounds (phenothiadine, etc.).

Chain Transfer Agent

Specific examples of the chain transfer agent include, but are not limited to, hydrocarbon [(compound having 6 to 24 carbon atoms such as aromatic hydrocarbon (toluene, xylene, etc.)], unsaturated aliphatic hydrocarbon (1-butene, 1-nonene, etc.), halogenized hydrocarbon compounds having 1 to 24 carbon atoms such as dichloromethane and carbon tetrachloride), alcohol (compounds having 1 to 24 carbon atoms such as methanol and 1-butanol), thiol (compounds having 1 to 24 carbon atoms such as such as ethylthiol and 1-octylthiol), ketone (compounds having 3 to 24 carbon atoms such as acetone and methylethyl ketone), aldehyde (compounds having 2 to 18 carbon atoms such as 2-methyl-2-propylaldehyde and 1-pentylaldehyde), phenol (compounds having 6 to 36 carbon atoms such as phenol, m-cresol, p-cresol, and o-cresol), quinone (compounds having 6 to 24 carbon atoms such as hydroquinone), amine (compounds having 3 to 24 carbon atoms such as diethylmethylamine and diphenylamine), disulfide (compounds having 2 to 24 carbon atoms such as di ethyl di sulfide and di-l-t-octyldisulfide).

Solution

For example, the solution mentioned above has hydrogen bond power.

Specific examples include, but are not limited to, water, alcohols such as butanol and hexanol, amines such as hexylamine and pentylamine, and aromatic compounds such as benzene and toluene. These can be used alone or in combination. Of these, water and alcohol are preferable in terms of safety.

In addition, the solution may include an additive.

Examples of the additive are surfactants. Such a surfactant can boost affinity to straight alkyl chains by selecting the kind and adjusting the content.

The temperature of the solution is preferably 40 degrees C. or higher to soften the support material and infiltrate into the inside. Also, to prevent a solid freeform fabrication object from being warped, it is possible to select temperatures lower than 40 degrees C.

Removability of Support

High power of the support to hold a shape for use in the present disclosure is considered to be secured due to hydrogen bond of the B component with the polymer in which the A is polymerized. For this reason, the power of the support to hold a shape is weakened and collapsed by dipping the support in water. As a result, the support can be removed. When the B has a low molecular weight, diffusion is rapid so that the support can be removed in a short time.

It is preferable to use water or water vapor to remove the support.

Other Optional Process

An example of the aforementioned other processes is a curing step.

Curing Process

The curing process is to cure the liquid film mentioned above.

The curing process can be conducted by, for example, an ultraviolet irradiator.

Ultraviolet Irradiator

The ultraviolet irradiator includes, for example, a high pressure mercury lamp, an ultra high pressure mercury lamp, and a metal halide lamp.

The ultra-high pressure mercury lamp is a point light source but if the DeepUV type combined with an optical system to have a high level of light use efficiency is used, the lamp is capable of emitting light in a short-wavelength range.

Since the metal halide has a wide range of wavelength, it is suitable for colored materials. Halogenated materials of metal such as Pb, Sn, and Fe are used and can be selected to suit to absorption spectrum of a polymerization initiator. The lamp for use in curing has no particular limit and can be suitably selected to suit to a particular application. Lamps available on the market such as H lamp, D lamp, or V lamp (manufactured by Fusion System) can be used.

It is preferable that the device for manufacturing a solid freeform fabrication object have no heater and can conduct fabrication at room temperature (for example, 20 to 32 degrees C.).

Device for Manufacturing Solid Freeform Fabrication Object

The device for manufacturing a solid freeform fabrication object includes an application device to apply a curable liquid composition in a desired pattern to obtain a depicted application film, a solidifying device to cure the depicted application film, and a controller to control humidity in the fabrication area.

As the curable liquid composition, the same curable liquid composition as used for the method of manufacturing a solid freeform fabrication object can be used.

The application device has no particular limit and can be suitably selected to suit to a particular application. For example, devices employing inkjet methods, dispenser methods are suitable.

The controller controls the humidity of the fabrication area (fabrication portion).

The humidity in the fabrication area is preferably 80 percent or less at 27 degrees C.

Embodiments of solid freeform fabrication formed with the curable liquid composition for use in the present disclosure are described next.

First, surface data or solid data of three-dimensional form designed by three dimensional computer-aided design (CAD) or taken in by a three-dimensional scanner or a digitizer are converted into Standard Template Library (STL) format, which is thereafter input into a lamination fabricating device.

Based on the input data, the direction of the fabrication direction of a three-dimensional shape to be fabricated is determined. The fabrication direction is not particularly limited. Normally, the direction is chosen such that the Z direction (height direction) is the lowest.

After determining the direction of the fabrication, the projected areas on X-Y plane, X-Z plane, and Y-Z plane of the three-dimensional form are obtained. The thus-obtained block form is sliced in the Z direction with a thickness of a single layer. The thickness of a single layer changes depending on the material. For example, it is about 20 to about 60 μm. When only one three-dimensional object is manufactured, this block form is arranged to be placed in the center of the Z stage (i.e., table on which the object lifted down layer by layer for each layer forming is placed). In addition, when a plural of three-dimensional objects are fabricated at the same time, the block forms are arranged on the Z stage. Alternatively, the block forms can be piled up. It is possible to automatically create these block forms, the slice data (contour line data), and the placement on the Z stage if materials to be used are determined.

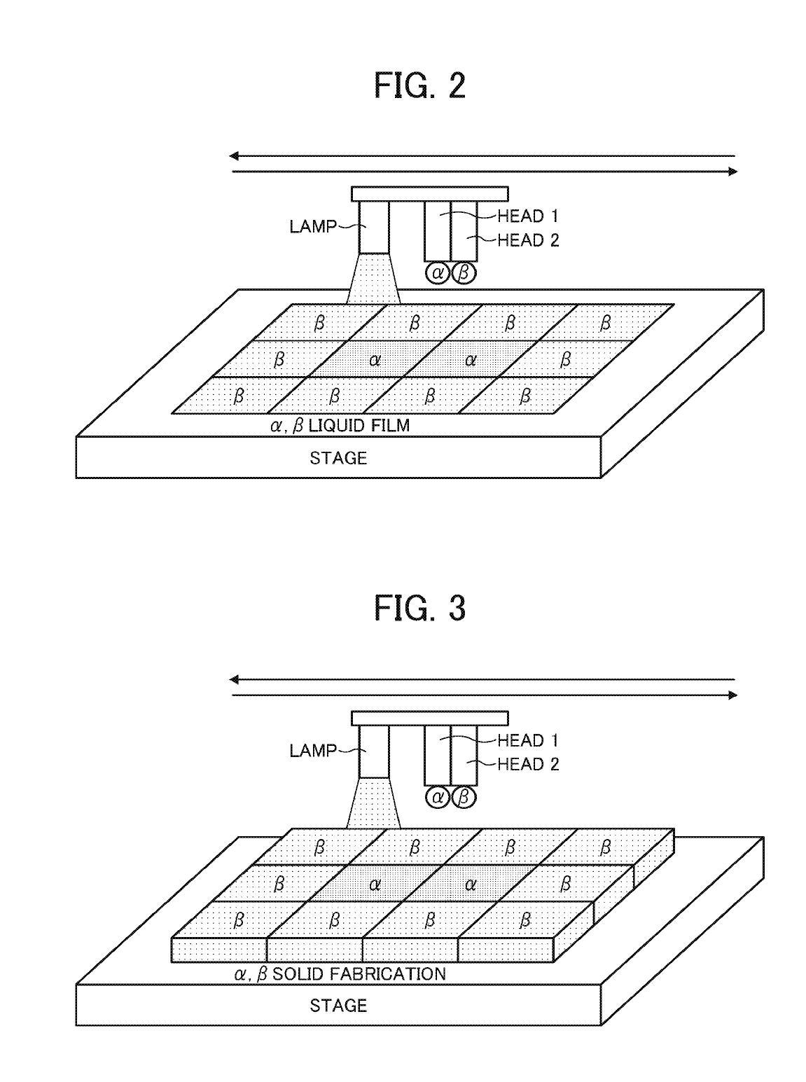

Next, fabrication step is conducted. Different heads 1 and 2 are moved in dual directions and spit a liquid α to form a model portion and a liquid β to form a support to form dots as illustrated in FIG. 2. Moreover, such dots are continuously formed to form a liquid film at desired sites. The liquid film is irradiated with ultraviolet (UV) ray to be cured to form a model film and a support film at the desired sites.

After a single layer of the model material film and the support material film is formed, the stage (FIG. 2) is lowered in an amount corresponding to the thickness of the single layer. Again, continuous dots are formed on the model material film and the support material film to form a liquid film at desired sites. Thereafter, the liquid film is irradiated with ultraviolet (UV) ray and cured to form a model material film and a support material film at a desired position. This lamination is repeated to form a three-dimensional object as illustrated in FIG. 3.

From the thus-obtained fabrication object, the support can be removed by the solution mentioned above to obtain a desired model portion.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples but not limited thereto.

### Example 1

Preparation of Liquid to Form Water Decaying Area

The following recipe was stirred in a beaker for 30 minutes to obtain the liquid to form the water decaying area.
Acryloylmorpholine (manufactured by KJ Chemicals Corporation): 50 parts
1,2-propylene diol (ethylene glycol, manufactured by Tokyo Chemical Industry Co. Ltd.): 50 parts
Polymerization initiator (hydroxycyclohexyl phenylketone (IRGACURE® 184, manufactured by BASF): 3 parts

Preparation of Liquid to Form Model Portion

As the liquid to form a model portion, AR-M1 (manufactured by KEYENCE CORPORATION) was used.

Preparation of Liquid to Form Area Other Than Water Decaying Area

The same liquid as the liquid to form the model portion was used.

Fabrication of Solid Freeform Fabrication Object

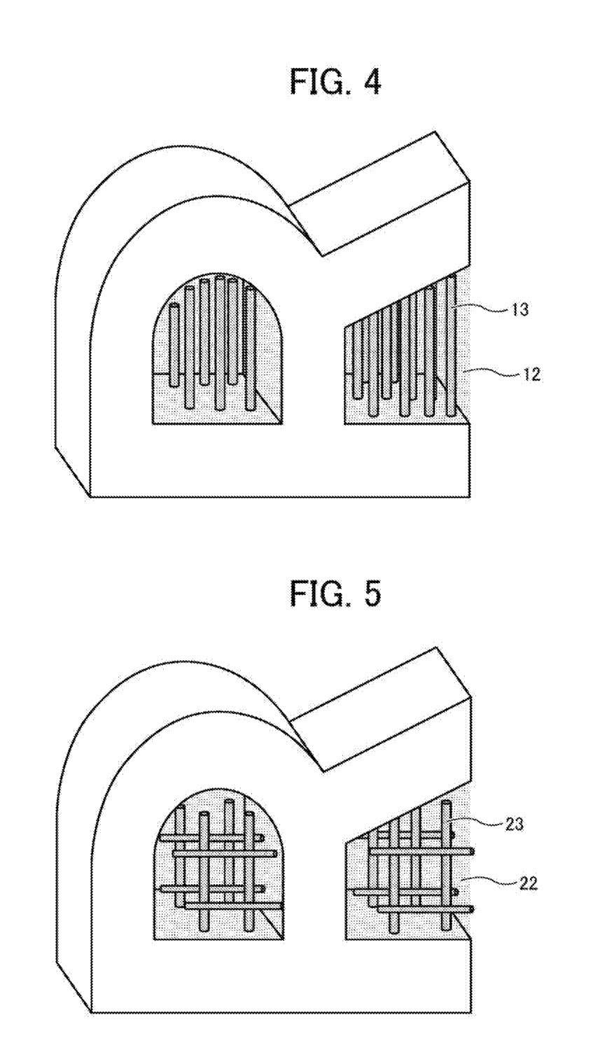

In the fabrication device illustrated in FIG. 2 with the cover closed (sealed), the form illustrated in FIG. 4 was formed. When monitoring the fabrication area with a thermo-hygrometer (TR-72wf, manufactured by T&D Corporation, the temperature slowly rose from 23 degrees C. to 27 degrees C. during fabrication. In addition, relative humidity transitioned between 50 percent and 80 percent.

Using an inkjet fabrication device having a configuration as illustrated in FIG. 2, the solid freeform fabrication object illustrated in FIG. 4 was fabricated. In FIG. 4, the reference numeral 12 represents the water decaying area and the reference numeral 13 represents the area other than the water decaying area. Using a GEN4 head (manufactured by Ricoh Company Ltd.) as the inkjet head, fabrication was conducted at a voltage frequency of 1 kHz while the discharging amount was adjusted to be 20 pL to 25 pL per droplet. The discharging amount per droplet was calculated based on the mass discharged for five minutes at 1 kHz. A solid freeform fabrication object was obtained by ultraviolet irradiation by an ultraviolet irradiator (SubZero-LED, manufactured by Integration Technology Japan) in an irradiation amount of 500 mJ/cm² (illuminance: 100 mW/cm², irradiation time: 5 seconds). In the thus-obtained solid freeform fabrication object, the water decaying area was formed as a single continuous area including a surface in contact with the model portion and at least a part of a surface of the support other than the surface in contact with the model portion.

### Example 2

A solid freeform fabrication object was obtained in the same manner as in Example 1 except that the area other than the water decaying area having a pillar-like form illustrated in FIG. 4 was changed to an area other than the water decaying area having a lattice-like form illustrated in FIG. 5. In FIG. 5, the reference numeral 22 represents the water decaying area and the reference numeral 23 represents the area other than the water decaying area. In the thus-obtained solid freeform fabrication object, the water decaying area was formed as a single continuous area including a surface in contact with the model portion and at least a part of a surface of the support other than the surface in contact with the model portion.

### Example 3

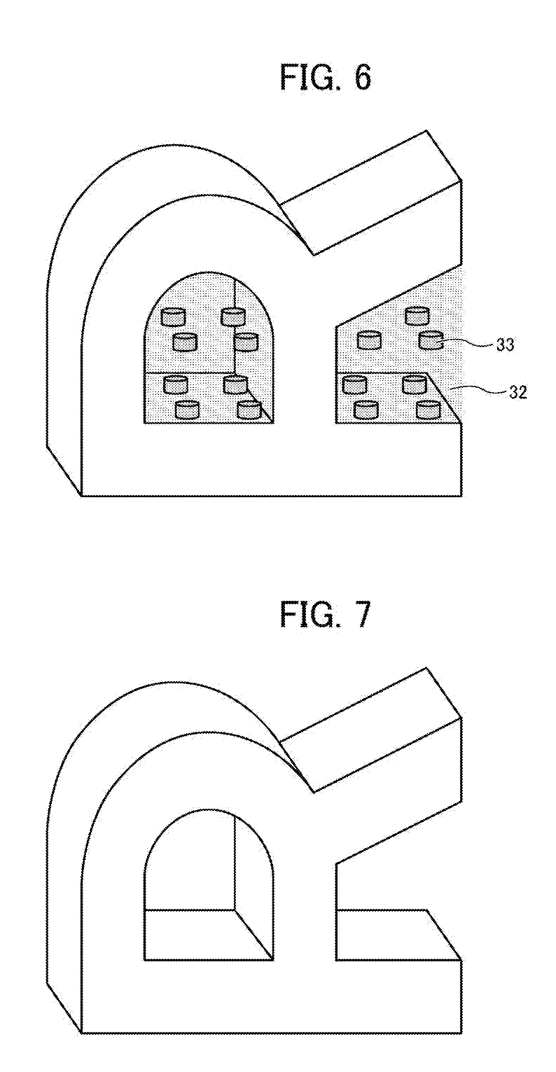

A solid freeform fabrication object was obtained in the same manner as in Example 1 except that the content of acryloylmorpholine was changed from 50 to 30 parts, 50 parts of 1,2-propylenediol was changed to 70 parts of 1,5-pentanediol, and the area other than the water decaying area B having a pillar-like form illustrated in FIG. 4 was changed to an area other than the water decaying area having a stepping stone-like form illustrated in FIG. 6. In FIG. 6, the reference numeral 32 represents the water decaying area and the reference numeral 33 represents the area other than the water decaying area. In the thus-obtained solid freeform fabrication object, the water decaying area was formed as a single continuous area including a surface in contact with the model portion and at least a part of a surface of the support other than the surface in contact with the model portion.

### Example 4

A solid freeform fabrication object was obtained in the same manner as in Example 1 except that a thermo-hygrometer mechanism was introduced and the temperature and the relative humidity were respectively maintained at 27 degrees C. and 40 percent. In the thus-obtained solid freeform fabrication object, the water decaying area was formed as a single continuous area including a surface in contact with the model portion and at least a part of a surface of the support other than the surface in contact with the model portion.

### Comparative Example 1

A solid freeform fabrication object was obtained in the same device and the same material except that the fabrication information of the support was input to constitute the surface of the support as an area other than the water decaying area having a thickness of 1 mm.

### Comparative Example 2

A solid freeform fabrication object was obtained in the same device and the same material except that the fabrication information of the support was input in order that the area other than the water decaying area of the support was non-continuously present in such a manner that the water decaying area having a surface in contact with the model portion and the water decaying area having a surface constituting the surface of the support were separated from each other.

The thus-obtained solid freeform fabrication objects were evaluated regarding “compression stress at 1 percent compression” and “Removability of support” in the following manner.

Compression Stress at 1 Percent Compression

A cube (water decaying area and at 1 percent compression) having a side of 30 mm of a support and a model portion was formed to measure the compression stress at 1 percent compression. The compression stress ((water decaying area and at 1 percent compression)) at 1 percent compression of the cube was measured by a universal tester (AG-I, load cell: 1 kN, compression jig for 1 kN) manufactured by Shimadzu Corporation).

Removability of Support

The thus-obtained solid freeform fabrication object was placed in a beaker and thereafter 100 ml of tapped water was charged therein to immerse the solid freeform fabrication object in water. After one and a half hours, the solid freeform fabrication object was taken out to obtain the model portion illustrated in FIG. 7.

Water was wiped off of the taken-out model portion, which was visually observed to evaluate “Removability of Support” according to the following criteria.

Evaluation Criteria

G (Good): No support remaining on solid freeform fabrication object observed

M (Marginal): Support remains on the model portion (support accounts for 30 to 50 percent by volume)

P (Poor): Support remains on the model portion (support accounts for more than 50 percent by volume)

TABLE 1

| | | | Evaluation result | | |
|---|---|---|---|---|---|
| | Fabrication condition | | Compression stress at 1 | | |
| | | Disposition of | percent compression (kPa) | | |
| | Humidity in | area other than | Water | Area other than | |
| | fabrication | water decaying | decaying | water decaying | Removability |
| | area | area | area | area | of support |
| Example 1 | 50-80 | Pillar | 0.2 | 50 | G |
| Example 2 | 50-80 | Lattice | 0.2 | 50 | G |
| Example 3 | 50-80 | Stepping stone | 1.0 | 50 | G |
| Example 4 | 40 | Pillar | 0.2 | 50 | G |
| Comparative | 50-80 | Outermost | 0.2 | 50 | P |
| Example 1 | | layer | | | |
| Comparative | 50-80 | Closest | 0.2 | 50 | M |
| Example 2 | | | | | |

It took two hours in Example 3 before the support was collapsed and removed.

It was rather difficult to take out a solid freeform fabrication object after fabrication in Example 4 because the outermost layer of the support was hard, which made the solid freeform fabrication object slippery when taking out.

It was possible to fabricate the solid freeform fabrication object in Comparative Example 1. However, since the wall was required to be removed, the edge of the solid freeform fabrication object partially chipped off when removing the wall.

Water serving as removing liquid did not infiltrate into the deep inside of the support in Comparative Example 2 so that most of the support was still attached to the solid freeform fabrication object.

Aspects of the present disclosure are, for example, as follows.

1. A method of manufacturing a solid freeform fabrication object includes forming a layer by solidifying a curable liquid composition by a solidifying device to form a solidified layer, repeating the forming to laminate the solidified layer to form a model portion and a support to support the model portion, and removing the support. The support has a water decaying area and an area other than the water decaying area, the water decaying area forming a continuous area including the surface of the support in contact with the model portion and at least a part of the surface of the support not in contact with the model portion.

2. The method according to 1 mentioned above, wherein the water decaying area has a compression stresses less than the area other than the water decaying area.

3. The method according to 1 or 2 mentioned above, wherein the area other than the water decaying area is enclosed with the water decaying area.

4. The method according to any one of 1 to 3 mentioned above, wherein the area other than the water decaying area is present as multiple non-continuous areas in the support.

5. The method according to any one of 1 to 4 mentioned above, wherein the area other than the water decaying area has a compression stress of 2 kPa or greater at 1 percent compression and the water decaying area has a compression stress of less than 2 kPa at 1 percent compression.

6. The method according to 5 mentioned above, wherein the water decaying area has a compression stress of less than 0.5 kPa at 1 percent compression.

7. The method according to 5 or 6 mentioned above, wherein the area other than the water decaying area has a compression stress at 1 percent compression 1.5 kPa or greater than the water decaying area.

8. The method according to any one of 1 to 7 mentioned above, wherein the volume ratio of the water decaying area to the total of the area other than the water decaying area and the water decaying area is from 50 percent to 95 percent.

9. The method according to 8 mentioned above, wherein the volume ratio is from 60 percent to 95 percent.

10. The method according to 9 mentioned above, wherein the volume ratio is from 70 percent to 90 percent.

11. The method according to any one of 1 to 10 mentioned above, wherein the area other than the water decaying area is disposed in a pillar-like form, a lattice-like for, or a stepping stone-like form in a lamination direction.

12. The method according to any one of 1 to 11 mentioned above, wherein the area other than the water decaying area and the model portion are formed of the same material.

13. The method according to any one of 1 to 12 mentioned above, wherein a liquid to form the water decaying area includes a monomer A having a hydrogen bond power and a solvent B having a hydrogen bond power, wherein the solvent B includes at least one of an alcohol compound, a carboxylic acid compound, an amine compound, an ester compound, a ketone compound, and a urea compound.

14. The method according to 13 mentioned above, wherein the water decaying area satisfies the following condition 1:

### Condition 1

When a cured object having a dimension of 20 mm×20 mm×5 mm obtained by irradiation of ultraviolet ray in an amount of 500 mJ/cm² with an ultraviolet irradiator is placed in 20 mL of water and left still at 25 degrees C. for one hour, the cured object is completely dissolved in the water or becomes a solid having a size of 1 mm or less at least in one direction.

15. The method according to 13 or 14 mentioned above, wherein the water decaying area satisfies the following condition 2:

### Condition 2

When a cured object (water decaying area) of the water decaying area obtained by irradiation of ultraviolet ray in an amount of 500 mJ/cm² by an ultraviolet irradiator has a compression stress of less than 2.0 kPa at 1 percent compression at 25 degrees C. and 2 g of the cured object is placed in 20 ml of water and left still at 25 degrees C. for one hour, the cured object is reduced to 50 percent by volume or less.

16. The method according to any one of 1 to 15 mentioned above, wherein the support is removed with water or water vapor.

According to the present disclosure, a method of manufacturing a solid freeform fabrication object is provided which includes fabricating a support having sufficient shape supporting ability and good removability

Having now fully described embodiments of the present invention, it will be apparent to one of ordinary skill in the art that many changes and modifications can be made thereto without departing from the spirit and scope of embodiments of the invention as set forth herein.

What is claimed is:

1. A method of manufacturing a solid freeform fabrication object, comprising:
forming a layer by solidifying a curable liquid composition by a solidifying device to form a solidified layer;
repeating the forming to laminate the solidified layer to form a model portion and a support to support the model portion; and
removing the support,
wherein the support includes a water decaying area and an area other than the water decaying area, the water decaying area forming a continuous area including a surface of the support in contact with the model portion and at least a part of a surface of the support not in contact with the model portion.

2. The method according to claim 1, wherein the water decaying area has a compression stresses less than the area other than the water decaying area.

3. The method according to claim 1, wherein the area other than the water decaying area is enclosed with the water decaying area.

4. The method according to claim 1, wherein the area other than the water decaying area is present as multiple non-continuous areas in the support.

5. The method according to claim 1, wherein the area other than the water decaying area has a compression stress of 2 kPa or greater at 1 percent compression and the water decaying area has a compression stress of less than 2 kPa at 1 percent compression.

6. The method according to claim 5, wherein the water decaying area has a compression stress of less than 0.5 kPa at 1 percent compression.

7. The method according to claim 5, wherein the area other than the water decaying area has a compression stress at 1 percent compression 1.5 kPa or greater than the water decaying area.

8. The method according to claim 1, wherein a volume ratio of the water decaying area to a total of the area other than the water decaying area and the water decaying area is from 50 percent to 95 percent.

9. The method according to claim 8, wherein the volume ratio is from 60 percent to 95 percent.

10. The method according to claim 1, wherein the area other than the water decaying area is disposed in a pillar-like form, a lattice-like for, or a stepping stone-like form in a lamination direction.

11. The method according to claim 1, wherein the area other than the water decaying area and the model portion are formed of a same material.

12. The method according to claim 1, wherein a liquid to form the water decaying area includes a monomer A having a hydrogen bond power and a solvent B having a hydrogen bond power,
wherein the solvent B is at least one of an alcohol compound, a carboxylic acid compound, an amine compound, an ester compound, a ketone compound, and a urea compound.

13. The method according to claim 12, wherein the water decaying area satisfies the following condition:
when a cured object having a dimension of 20 mm×20 mm×5 mm obtained by irradiation of ultraviolet ray in an amount of 500 mJ/cm² with an ultraviolet irradiator is placed in 20 mL of water and left still at 25 degrees C. for one hour, the cured object is completely dissolved in the water or becomes a solid having a size of 1 mm or less at least in one direction.

14. The method according to claim 12, wherein the water decaying area satisfies the following condition:
when a cured object of the water decaying area obtained by irradiation of ultraviolet ray in an amount of 500 mJ/cm² by an ultraviolet irradiator has a compression stress of less than 2.0 kPa at 1 percent compression at 25 degrees C. and 2 g of the cured object is placed in 20 ml of water and left still at 25 degrees C. for one hour, the cured object is reduced to 50 percent by volume or less.

15. The method according to claim 1, wherein the support is removed with water or water vapor.
